(19) United States
(12) Patent Application Publication
(10) Pub. No.: US 2003/0217163 A1
(43) Pub. Date: Nov. 20, 2003

(54) Method and system for assessing a right of access to content for a user device

(76) Inventors: Lambertus Lagerweij, Utrecht (NL); Ferry Bult, Ijsselstein (NL)

Correspondence Address: Steven M. Koehler, WESTMAN CHAMPLIN & KELLY, International Centre - Suite 1600, 900 South Second Avenue, Minneapolis, MN, 55402-3319, US

(21) Appl. No.: 10/150,751

(22) Filed: May 17, 2002

(51) Int. Cl. G06F 15/16

(52) U.S. Cl. 709/229; 709/232

(57) ABSTRACT

The invention relates to a conditional access method and system for assessing a right of access to content for a user device wherein a data-string is generated by a generating module of an access server and the data-string at least comprises access right data expressing the right of access which data-string is sent to the user device. A content server receives at least the access right data and comprises an assessment module for assessing the right of access based on the access right data. The system can be easily expanded with further access servers and/or further content servers.

### BACKGROUND OF THE INVENTION

The invention relates to a method and system for assessing a right of access to content for a user device. More particular the invention relates to a method and system to assess a right of access to content for a user device in order to safeguard the intellectual property rights on said content. The invention further relates to an access server and a content server being adapted to provide a right of access and to provide access based on said right of access.

The internet is an important channel for distribution of valuable content like news, sports and entertainment. Live or on-demand audio and video is made available to end-users on user devices such as a PC, a Set Top Box, a Personal digital assistant (PDA), a mobile phone, etc. Although today millions of streams find their way to consumers over IP-networks and other networks, the inability to create value for this content in a scalable and cost effective way, hold back many content owners from providing their content to a large public.

Business models based on advertising around free content have not proven to be profitable. The future lies in a direct transaction in exchange for access to valuable content that is offered in several different models like pay-per-view, pay-per-minute or subscriptions. In many occasions a transaction is processed, but the content is not protected against illegal access at all.

A first approach to protect content is through Digital Right Management (DRM). WO02/23314 discloses a DRM system for securely publishing and controlling the usage of digital content. The DRM system comprises three main elements; namely a content delivery system, a licensing server and a user device. The content is transmitted or sent to the user in encrypted form by the content delivery system, so the content is protected on the client side (i.e. the user device). The user device needs a special application for having access to the content. A corresponding set of license rules for the content are sent by the content delivery system to the licensing server. Subsequently the user device connects or is redirected to the licensing server and retrieves the license rule file from the licensing server. Access to the encrypted content is obtained according to these license rules. Such a DRM system can not be applied to live content streams, since live content cannot be encrypted.

A second and different approach to protect content streams is conditional access (CA). In this approach content itself is not protected, but the access to the content is protected. CA-systems are therefore also applicable to live content streams. In a typical CA-system a provider uses a firewall to protect content against illegal use. Such a system is shown in FIG. 1 and is discussed in more detail in the description. However, building such a CA-system infrastructure that is able to support this protection is a complex and therefore costly matter.

The systems described above have a number of disadvantages. Websites and payment systems that offer and charge content to end-users can be located anywhere in the world. Content Delivery Networks (CDNs), server farms and single streaming servers that distribute this content, may be located elsewhere or may be distributed over the internet.

A first disadvantage relates to the need to have some kind of connection between the system that offers the content (content access) and the system that actually delivers the content (content delivery) in order to provide access for a user device to content of a secure nature. This connection gives rise to a number of problems amongst which are the frequent proprietary nature of the interfaces of the systems and the high costs of the continuous connection between the systems. Moreover scalability of the systems is limited, since connecting new content access systems to an existing delivery environment or adding new content delivery system to an existing access environment needs integration. In general existing systems have a one-to-one character, i.e. one content access system is connected to one content delivery system. Scaling to multiple content access systems and/or multiple content delivery systems is costly and difficult.

A second disadvantage of the existing systems is that the actual security of the content is limited. The system using a firewall mentioned above uses IP-addresses assigned to user devices to identify an individual user device. However, if a user device is connected via a proxy-server all the user devices connected appear to have the same IP-address for the system. Therefore all users employing a user device behind the proxy-server have access to the secure stream of content. The existing system thus is not able to uniquely identify an individual user device. Moreover, since IP-addresses are frequently assigned dynamically to a user device by an Internet Service Provider (ISP) additional services are difficult to provide to end users employing a user device. For example automatic reconnection to a stream of content if a previous connection to the stream is broken may not succeed if the ISP has assigned a different IP-address to the user device.

A third disadvantage of the system using a firewall is that the content delivery system can not provide streams of a secure nature and streams of a non-secure nature from the same content delivery server, since a firewall cannot distinguish between request from user devices for secure and non-secure content. The content delivery provider thus needs separate servers for the secure and the non-secure content if this provider wishes to host both streams.

### SUMMARY OF THE INVENTION

It is an object of the invention to provide an improved method and system for providing access to and delivery of content to a user device which is more flexible and less costly than the existing methods and systems.

The invented method entails assessing a right of access to content for a user device comprising the steps of

generating a data-string by a generating module of an access server, said data-string at least comprising access right data expressing said right of access;

sending said data-string to said user device;

receiving said data-string comprising at least said access right data from said user device at a content server comprising an assessment module;

performing an assessment by said assessment module assessing said right of access for said user device based on said access right data.

The invented system for assessing a right of access to content for a user device entails an access server comprising a generating module and a content server comprising an assessment module, said access server being adapted to receive a request from said user device and said generating module being adapted to generate a data-string in response to said a request, said data-string at least comprising access right data expressing said right of access, and sending said data-string to said user device, said content server being adapted for receiving said data-string comprising at least said access right data and said assessment module being adapted for performing an assessment to assess said right of access for said user device based on said access right data.

The method and system provide a more flexible and less costly way in providing access and delivering content to a user device since a connection or at least an interaction between the access server and the content server is no longer required while the right of access for a user device to the content can still be assessed. This result is achieved by including the access right data in the communication stream between the access server and the user device. These access right data can be read and verified by the assessment module. As a result no direct connection is required between the access server and the content server. Therefore no or only minimal integration is required between the access server and the content server and scalability of the system is high. There is no need for integration with firewalls.

In a further aspect of the invention the right of access can be made subject to one or more access conditions which conditions can be used in performing the assessment. This embodiment provides an optimal flexibility in defining the access rights for a user device.

In a further aspect of the invention the data-string is sent to the user device as a uniform resource locator (URL) that comprises access right data and a signature to prevent tampering. The data-string may further comprise data relating to other usage data. It is particularly advantageous to include a unique order identifier, relating to the specific request for content, in the data string or URL. This unique order identifier may be made available to the assessment module and used in performing the assessment as a result of which a subsequent request for the information using of the same URL can be denied, since the assessment module monitors the use of the same order identifier. Moreover it is advantageous to include re-direction information in the data-string sent by the access server in order to enable the user device to automatically connect to the content server.

In a further aspect of the invention a method and system are provided having high security of a content stream. This is achieved by using a global unique identifier for the user device media application. The use of this global unique identifier makes it more difficult for another user device to illegally connect to a secure stream of content, even if the user device uses the same IP-address. Since the user device can be identified by using a unique identifier additional services, such a automatic re-connection upon a broken connection, can be provided to the end user employing a user device.

In a further aspect of the invention the data-string is encrypted using public-private key technology. The public key of the access server is known to the content server in order to decrypt the data-string and/or access right data.

In a further aspect of the invention the content server can act as a host for requests of content of both secure and non-secure nature, since the assessment module is able to distinguish between content of a secure and a non-secure nature.

In a further aspect of the invention multiple access servers and/or multiple content servers can be employed for providing rights of access to content and delivering content respectively. Since a connection between an access server and a content server is no longer needed, scalability and integration issues are less relevant.

The invention further relates to a computer program product suitable for applying the method and an access server and a content server suitable to be implemented in the system.

It will be appreciated that the previous embodiments or aspects of the previous embodiments of the invention can be combined.

### BRIEF DESCRIPTION OF THE DRAWINGS

The embodiments of the invention will be described into more detail below with reference to the attached drawing of which:

FIG. 1 illustrates schematically a system for providing a right of access and delivering content according to the prior art;

FIG. 2 illustrates schematically a system for providing a right of access and delivering content according to a first embodiment of the invention;

FIG. 3 illustrates schematically a system for providing a right of access and delivering content according to a second embodiment of the invention;

FIG. 4 illustrates schematically a system for providing a right of access and delivering content according to a third embodiment of the invention;

FIG. 5 illustrates schematically a system for providing a right of access and delivering content according to a fourth embodiment of the invention.

### DESCRIPTION OF THE PREFERRED EMBODIMENTS

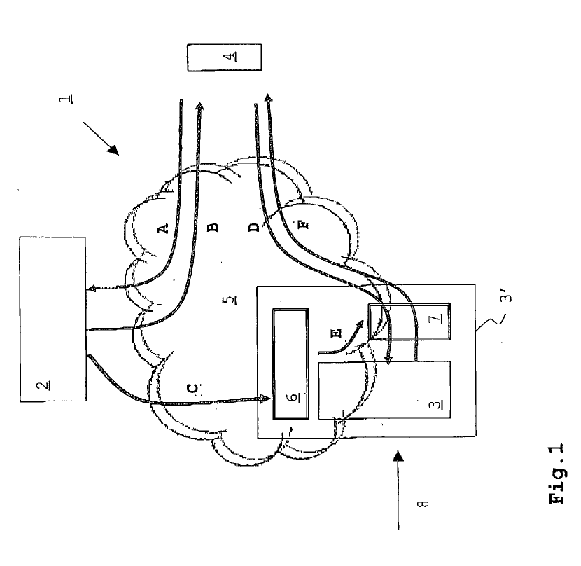

FIG. 1 illustrates schematically a CA-system 1 for providing a right of access and delivering content according to the prior art. The system 1 comprises three main components, namely an access server 2, a content server 3 and a user device 4. The components are connected to each other by a communication network 5.

The access server 2 may host a web-site or an e-commerce application offering content to a user (not shown) employing a user device 4. Such a user device 4 may be a PC, a television set with a set top boxes, a personal digital assistant (PDA), a mobile phone, etc. The user device 4 is adapted to be able to connect to the communication network 5. The communication network 5 may be a wired network such as an intranet or the internet as well as a wireless network such as a GSM, GPRS or a UMTS network. The content server entity 3′ comprises the content server 3 and further comprises an access management application 6 and a firewall 7.

The operation of the system 1 is indicated by the arrows A-F. A request A comes from the user device 4. This request is made by a user employing his user device 4 to request content or access to content available on e.g. a website or e-commerce application hosted by the access server 2. This request may e.g. relate to a username/password login at a subscriber management system or a money transaction through a payment system. In step B the access server 2 sends a URL that is received by the user device 4 giving the user a right of access to a secure stream of content indicated by the arrow 8. The streaming content may be any kind of digital content, such as fleeting content relating to live or on-demand audio and video content. The content 8 is present at or available by the content server 3 that may be located in at a location different from the location of the access server 2. The subscriber management system or payment system hosted by the access server 2 is connected via the network 5 to the access management application 6 of the content server entity 3′. In step C the access management application 6 stores information relating to which user device 4 has or should have access to what (part of) the content 8. Typically the access management application 6 is installed on the site where the firewall 7 and the content server 3 runs. In step D the request of step A for the content 8 by the user device 4 is re-directed by the URL, received in step B, to the content server 3. Re-directing of the user device 4 to the content server 3 is the sole relevant function of the URL. If such a request is detected by the firewall 7, in step E the right of access to the content 8 for the user device 4 is retrieved by the firewall 7 from the access management application 6. The firewall 7 manages the access by subsequently allowing or denying access to the content 8 based on the information retrieved from the access server 2 in step C. If access to the content 8 is allowed, the content 8 is sent or transmitted to the user device 4 as shown in step F.

This system 1 has some disadvantages referred to previously. Next, embodiments of the invention that at least partly avoid the disadvantages are presented. The embodiments presented intelligently link the access server 2 to the content server 3 without the need for heavy-weight integration between the access server 2 and the content server 3.

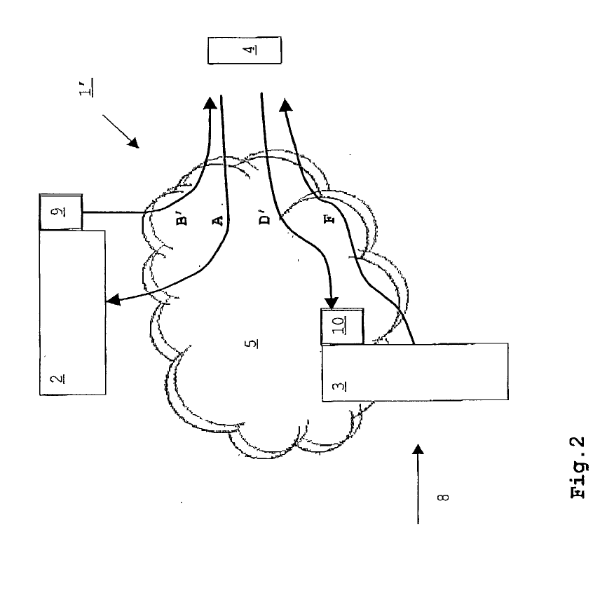

In FIG. 2 a CA-system 1′ for providing a right of access and delivering content according to a first embodiment of the invention is illustrated. At this point it should be noted that the invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. Tasks performed by the programs and modules are described below and with the aid of figures. Those skilled in the art can implement the description and figures as processor executable instructions, which can be written on any form of a computer readable media or computer program product.

The devices discussed below and illustrated in the figures typically include a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The main components of the system 1′ are an access server 2, a content server 3 and a user device 4. For a description of the user device 4 reference is made to the devices and characteristics described for FIG. 1. The user device 4 preferably has a browser such as the Internet Explorer of the Netscape Navigator and a audio/video player such as a Windows media player or a RealPlayer. This player can preferably be identified by a global unique identifier (GUID) of the media player. An example of a GUID is 632608d2-1215-43bf-bb2e-a8938c990f80 for a Windows media player. The communication network 5 may again be a wired network such as an intranet or the internet as well as a wireless network such as a GSM, GPRS or a UMTS network. The communication network 5 is such that the user device 4 should be able to connect to both the access server 2 and the content server 3. A direct connection between the access server 2 and the content server 3 is not necessary in contrast to the situation described in FIG. 1 being the prior art.

The access server 2 comprises or has a connection with a generating module 9. The generating module 9 may be a script written in Java, Perl or as an Active-X control and can be installed on the access server 2 (webserver, mailserver etc.) or be integrated in a e-commerce application. This generating module 9 is adapted to generate a data-string such as a license. This data-string is preferably a URL that comprises access right data and a signature. Such a URL may e.g. read: mms://demo.dmdsecure.com/secure-demo?orderid=1021541407887&outletid=demo&allowhttp=yes&allowpause=yes&contentduration=66&voucherexpiration=20020516093307&signature=MCwCFEr4x%2F15qpnVOxutyZ5vecajEIiRAhRLrZeHcxk5dC7RrZjlJFMRmYyenA%3D%3D. The access server 2 hosts e.g. a web-site, an e-commerce application or a subscriber management system on which the generating module 9 performing the function of a license generator is installed. The generating module 9 enables e.g. the owner of the content to define the right of access according to business rules defined and configurable by this owner. The right of access to the content 8 can thus be made subject to the conditions defined by these business rules. This feature enables one to control usage of the content 8 next to managing access to the content 8. A business rule may e.g. relate to content duration, i.e. access to a content stream 8 is allowed only for a limited time, after which access is blocked. One could grant a user employing a user device 4 access to a content stream 8 for the next 12 hours for example. The duration can be specified on a per second base, so pay per minute is perfectly possible. Another business rule may relate to content expiration, i.e. access to the content stream 8 is or can be allowed till a predefined point in time. One could grant an end-user employing a user device 4 access to the content stream 8 till for example 12 Sep. 2002, 12:45 PM. Still another business rule may relate to the allowance of start/stop and pause of the content stream 8, i.e. the user is allowed to stop, pause and restart a stream without losing the rights to the remaining time to watch. If an end-user buys the right to watch a football match for 60 minutes and start/stop is allowed, he might be able to see the first 30 minutes, stop the stream and watch the last 30 minutes of the game afterwards. Yet another business rule may relate to the license expiration, i.e. in order to limit the possibility for an end-user to illegally copy or forward a license, the license has a configurable expiration time (specified in seconds). Within the expiration time, the end-user must click on the license to get access to the stream 8. After the expiration time, the license will not work anymore. As a final example of a business rule, http-streams can be allowed or denied. As streams over HTTP can be captured easily with software tools, it is a relatively unsafe streaming method. A license can be configured not to allow this streaming method and only allow non HTTP protocols (UDP and TCP) to prevent capture of streams 8.

The content server 3 comprises or has a connection to a assessment module 10 that may function as a gatekeeper. This assessment module may be a plug-in written in C++ and be installed on the content server 3. The assessment module 10 does not affect unprotected content streams. Unprotected streams pass straight through the assessment module 10 giving the advantage to provide secure content 8 and non-secure content from the same server 3. The assessment module further is adapted to store an order ID of a request for content 8 as will be explained below. Moreover the assessment module 10 is preferably adapted to use the GUID of the audio/video player of the user device 4. The assessment module 10 can be configured to reject http-requests to prevent http-capturing by e.g. proxy software. HTTP data packets can be easily captured and saved to a storage module of a user device 4. There are freely available tools that enable capturing of streaming content in Windows Media Format to a storage module if the http-protocol is used. The resulting files can be played with Windows Media Player. Thus, secure content streams 8 can be saved and illegally distributed to other consumers. UDP and TCP are ‘lower level protocols’. There are currently no tools available that can capture streams that use UDP or TCP (without http on top). Content distributors may not find switching off the http protocol desirable. Therefore the assessment module 10 may be configured to prevent the streaming of secure content using the http protocol. If http-streaming is not allowed, a user employing a user device 4 who wants to stream using http will not receive the content stream 8 unless the user-device 4 uses UDP or TCP. Http-streaming can be denied by default, on a per content server 3 basis or it can be specified (as a right) in each request for secure content 8. Requests for non-secure content over http will not be affected in a any way.

The operation of the system 1′ is illustrated by the arrows A, B′, D′ and F in FIG. 2 and will now be discussed.

A request A comes from the user device 4. This request is made by a user employing his user device 4 to request content or access to content available on e.g. a website or an e-commerce application hosted by the access server 2. This request may e.g. relate to a username/password login at a subscriber management system or a money transaction through a payment system. It should be noted that an actual request for the content or the access to content may not be needed at the same time the content is actually wanted to be received by the user device 4. It is e.g. possible that an earlier request for the content is made, which request is stored for some time and be executed later on. This later moment in time may be programmed by the user if the website or the e-commerce application allows to do so. In such a case the order identifier can be stored in a database (not shown in FIG. 2) connected to the assessment module. If the user-device 4 requests a content stream 8 the order identifier is checked using the database. The license itself, embedded in the data-string, may have a limited lifetime. If the transaction is completed the generating module 9 generates a data-string, which data-string comprises at least the access right data expressing the right of access for the user device 4. This data-string or these access right data preferably relates to a license for having access to the secure content stream 8. The data-string is encrypted using public-private key technology. Public key infrastructure (PKI) enables users of a basically unsecure public network 5, such as the internet, to securely and privately exchange data and money through the use of a public and a private cryptographic key pair that is obtained and shared through a trusted authority. When the data string is generated an unsigned URL is prepared by the generating module 9, including a new order identifier which will be discussed in more detail below. A message digest is calculated using a secure hashing algorithm (SHA-1). The message digest is signed with the private key of the access server 2 using a digital signing algorithm (DSA). Next the signature is encoded and added to the URL as a signature parameter. For further information on SHA reference can be made to http://www.itl.nist.gov/fipspubs/fip180-1.htm.

In step B′ the data string, but at least the access right data are sent to the user device 4. The data-string may further comprise an order identifier relating to the specific request for the content. The data-string may also comprise re-direction information in order to automatically connect the user device 4 to the content server 3. The data-string may also comprise usage data incorporating one or more business rules wherein the right of access is made subject to one or more particular conditions as described previously. The data-string is sent to the user device 4 preferably in the URL.

In step D′ the user device 4 connects to the content server 3. The content server 3 preferably receives from the user device 4 the data-string generated by the generating module 9 of the access server 2, but at least the access right data expressing the right of access to the content 8 given to the user device 4. These access right data refer to the license issued by the generating module 9. The content server 3 comprises the assessment module 10 acting as a gatekeeper assessing the right of access for the user device based on the access right data. Assessing the right of access involves the verification or establishment of the right of access leading to granting or denying a right of access to the content stream 8, but may also involve an intermediate result, i.e. a temporary denial of the access or a conditional grant of the access to the content stream 8. Such an intermediate result can be used e.g. if a limit is to be set on the number of concurrent users requesting the content stream 8.

Preferably the data-string received by the content server 3 also comprises the unique order identifier relating to the specific request and generated by the generating module 9. This unique order identifier is made available to the assessment module 10 as a result of which access to the content stream 8 is denied to a user device 4 requesting content 8 using the same license or access right data. The assessment module 10 may store the order identifier in a temporary memory, so assessment modules 10 installed on one or multiple content servers 3 do not need to to be connected to a database of order identifiers. Integration with a database is therefore not necessary.

The user device 4 can be identified by the content server 3 using the GUID of the media player of the user device 4. The GUID may be obtained by the content server 3 during the establishment of the connection with the user device 4. This GUID can e.g. be used by the content server 3 for intelligent reconnection. Congestion of the communication network 5 or a drop out of a dial-up connection may interrupt a stream of content to the user device 4. If the session is still active, the player may automatically reconnect. Even if a session has timed out and the end-user is dynamically assigned a new IP-address, the user device 4 may be able to intelligently reconnect to the stream. The content server 3 uses the GUID of the media player to do so.

The data-string is preferably received by the content server in encrypted form, using public-private key technology. Encryption was applied at the site of the access server 2 by the generating module 9. In order to deliver the content stream 8 to the user device, decryption of the data-string is employed. The signature parameter is first removed from the request URL. Next the message digest is calculated using SHA-1, said calculated message digest, the supplied signature and the public key of the access server 2 are used to perform a DSA assessment or verification operation. If this operation is successful the URL is verified as authentic. If the assessment module 10 in performing the assessment based on the access right data results in the grant of access to the content stream the content is send or transmitted to the user device 4 shown by step F in FIG. 2. If a duration or expiration is defined in the data-string the assessment module will close the content stream 8 to the user device 4 accordingly. The user device will not have access to the content 8 if access is denied by the assessment module 10.

The system 1′ illustrated in FIG. 2 can be used in many ways. Users can be offered a live concert, web-casted by the content server 3, viewing blocks of 5, 10 and 15 minutes for separate prices, so the users employing a user device 4 may decide themselves how long they want to attend the concert. Another example relates to a live webcast of a Formula 1 racing event. A limited amount of licenses to a live webcast of the Formula 1 race may be sold. After 50.000 licenses have been issued by the access server 2, the race is sold out and it is known exactly how many users can be expected. This information can be used to control bandwidth cost. The race ends at 11:00 PM, that is when normal licenses expire defined by a business rule. To 5.000 fans who want to see the award ceremony between 11:00 PM and 12:00 PM, licenses that expire at 12:00 PM are sold at a premium rate.

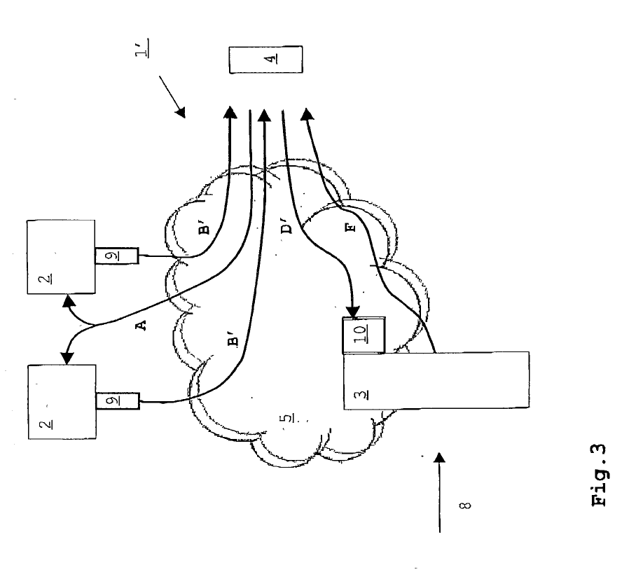

Note that in the system 1′ and method described above no connection or at least no direct interaction between the access server 2 and the content server 3 is needed as a result of which scalability of the system 1′ in greatly enhanced, as will be shown in FIGS. 3, 4 and 5.

FIG. 3 shows a system 1′ wherein multiple access servers 2 are deployed. Preferably each access server 2 has a generating module 9 installed, but multiple access servers 2 may share a generating module 9. Further the system 1′ comprises a single content server 3. According to this embodiment of the invention the content server 3 comprises only a single assessment module 10. The assessment module 10 is adapted to receive requests from a user device 4 that has made requests A for access to content 8 wherein multiple access servers have been approached. The URL generated by the generation module 9 comprise a customised name or identifier, specific for the access server 2. The assessment module 10 has stored or supports these customised unique name for each generation module. The assessment module 10 also holds a separate public key for each access server to decrypt the data-string comprising at least the access right data generated by the generating module 9. The public key and the identifier can be obtained in a number of ways. If the access server 2 and the content server 3 are connected by a network the public key and the identifier can be obtained via this network, e.g. by e-mail. These modifications comprise the most relevant changes with respect to the system 1′ presented in FIG. 2. Therefore scaling up of the system 1′ can be very easily obtained.

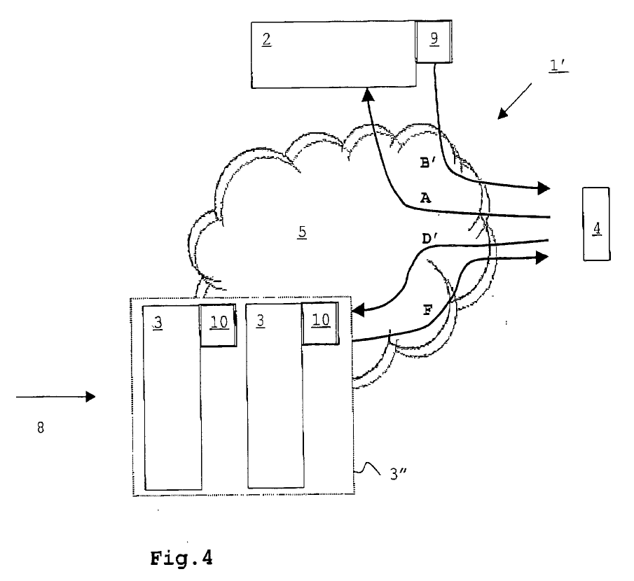

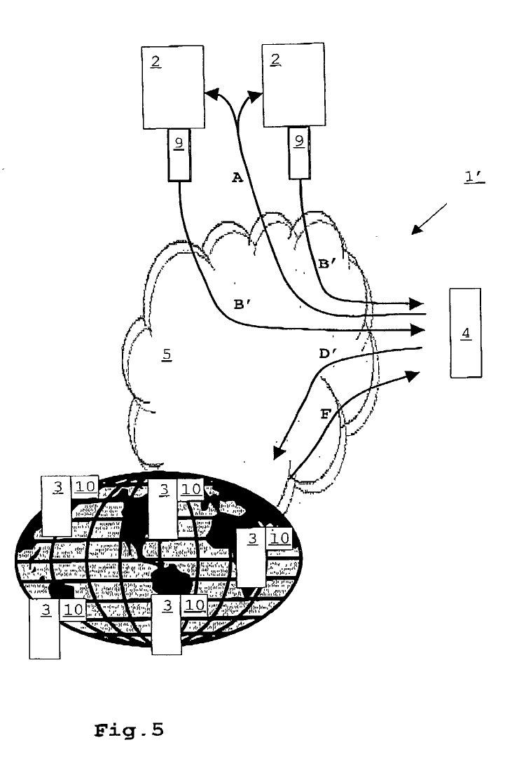

FIGS. 4 and 5 show the deployment of multiple assessment modules 10 installed on a clustered set 3″ or a distributed set of content servers 3. Moreover in FIG. 5 the deployment of multiple generating modules 9 on access servers 2 is illustrated. Thus, multiple assessment modules 10 can support multiple generating modules 9 and vice versa. Co-operation of the entities in the systems 1′ presented, only requires that the assessment modules 10 have an identifier of the access server 2 the and the public key of the generating module. The systems 1′ presented in FIGS. 4 and 5 operate in a similar way as described for the systems shown in FIGS. 2 and 3.

For the purpose of teaching the invention, preferred embodiments of the method and system for generating and assessing a right of access for a user device have been described above. It will be apparent for the person skilled in the art that other alternative and equivalent embodiments of the invention can be conceived and reduced to practice without departing from the true spirit of the invention, the scope of the invention being only limited by the claims.

What is claimed:

1. Method for assessing a right of access to content for a user device comprising the steps of:
generating a data-string by a generating module of an access server, said data-string at least comprising access right data expressing said right of access;
sending said data-string to said user device;
receiving said data-string comprising at least said access right data from said user device at a content server comprising an assessment module; and
performing an assessment by said assessment module assessing said right of access for said user device based on said access right data.

2. Method according to claim 1 wherein said method further comprises the steps of receiving a request at said access server and generating said data-string in response to said request.

3. Method according to claim 1 or 2 wherein said method further comprises the step of granting or denying access to said content present at or available via said content server based on said assessment.

4. Method according to claim 1 wherein said right of access is subject to one or more conditions expressed in said access right data and at least some of said conditions are used in performing said assessment.

5. Method according to claim 1 wherein said data-string is a URL comprising said access right data.

6. Method according to claim 5 wherein said data-string further comprises unique order information, re-direction information and at least one of usage rights.

7. Method according to claim 1 wherein said user device is identified based on a global unique identifier.

8. Method according to claim 7 wherein said global unique identifier is used for reconnecting said user device to said content server.

9. Method according to claim 1 wherein said access right data are encrypted using at least public-private key technology.

10. Method according to claim 9 wherein said content server has a copy of said public key of said access server.

11. Method according to claim 1 wherein multiple access servers and/or multiple content servers are employed, at least some of said multiple access servers comprising a generating module being able to generate said data-string and at least some of said content servers comprising a assessment module being able to assess said right of access for said user device.

12. Method according to claim 11 wherein said access right data are encrypted using at least public-private key technology and said assessment module has a copy of said public key for each generating module and an identifier for each access server.

13. Computer program product for assessing a right of access to content for a user device at least including software code portions for:
generating a data-string by a generating module of an access server, said data-string at least comprising access right data expressing said right of access;
sending said data-string to said user device;
receiving said data-string comprising at least said access right data from said user device at a content server comprising an assessment module;
performing an assessment by said assessment module assessing said right of access for said user device based on said access right data.

14. Computer program product according to claim 13 further comprising software code portions for receiving a request from said user device and generating said data-string in response to said request.

15. Computer program product according to claim 13 or 14 further comprising software code portions for granting or denying access to said content present at or available via said content server based on said assessment.

16. Computer program product according to claim 13 further comprising software code portions for making said right of access subject to one or more conditions expressed in said access right data.

17. Computer program product according to claim 16 further comprising software code portions for using at least some of said conditions in performing said assessment.

18. Computer program product according to claim 13 further comprising software code portions for encrypting said access right data using public-private key technology.

19. System for assessing a right of access to content for a user device comprising an access server comprising a generating module and a content server comprising an assessment module, said access server being adapted to receive a request from said user device and said generating module being adapted to generate a data-string in response to said a request, said data-string at least comprising access right data expressing said right of access, and sending said data-string to said user device, said content server being adapted for receiving said data-string comprising at least said access right data and said assessment module being adapted for performing an assessment to assess said right of access for said user device based on said access right data.

20. System according to claim 19 wherein said assessment module is further adapted to grant or deny access to content present at or available via said content server based on said assessment.

21. System according to claim 19 said system comprising multiple access servers and/or multiple content servers.

22. Access server for providing a right of access to a user device, said access server comprising a generating module adapted for generating a data-string at least comprising access right data expressing said right of access and sending said data-string to said user device.

23. Access server according to claim 22 said access server further being adapted to receive a request from said user device, said generating module being adapted to generate said data-string in response to said request.

24. Access server according to claim 22 or 23 wherein said generating module is adapted to send said data-string at least comprising said access right data to said user device as a URL.

25. Access server according to claim 24 wherein said data-string further comprises unique order information and/or re-direction information and/or usage rights.

26. Access server according to claim 22 wherein said access server is adapted to send said data-string to said user device using public-private key technology.

27. Content server for providing access to content to a user device having a right of access, said content server being adapted to receive a data-string from said user device at least comprising access right data expressing said right of access, said content server further comprising an assessment module adapted for performing an assessment assessing said right of access to said content for said user device based on said access right data.

28. Content server according to claim 27 wherein said assessment module is further adapted to grant or deny access to said content present at or available via said content server.

29. Content server according to claim 27 or 28 wherein said right of access is subject to one or more conditions and said assessment module is adapted to use at least some of these conditions in performing said assessment.

30. Content server according to claim 27 wherein said content server further is adapted to store unique order information relating to a request for said content and said assessment module is adapted to used said unique order information in performing said assessment.

31. Content server according to claim 27 wherein said content server further comprises means for identifying said user device by a global unique identifier.

32. Content server according to claim 31 wherein said content server comprises means for re-connecting to said user device by using said global unique identifier.
